(19) United States
(12) Patent Application Publication
(10) Pub. No.: US 2024/0295398 A1
(43) Pub. Date: Sep. 5, 2024

(54) Plate Level

(71) Applicant: Johnson Level & Tool Mfg. Co., Inc., Mequon, WI (US)

(72) Inventor: Timothy Wojciechowski, Hubertus, WI (US)

(21) Appl. No.: 18/585,992

(22) Filed: Feb. 23, 2024

Related U.S. Application Data
(60) Provisional application No. 63/449,150, filed on Mar. 1, 2023.

(51) Int. Cl. G01C 9/26; G01C 9/36

(52) U.S. Cl. CPC G01C 9/26; G01C 9/36

(57) ABSTRACT

An extendable level includes a base frame having an internal passage, an extension member positioned within the internal passage and movable between an extended position and a retracted position relative to the frame, and a retainer mechanism for securing the extension member in position relative to the frame. The retainer mechanism is in the form of a modular retainer assembly that can be assembled as a unit to the base frame. The retainer mechanism includes a positioning arrangement that is configured to prevent movement of the extension member relative to the frame at predetermined positions of the extension member relative to the frame via a first engagement arrangement, and is further configured to resist movement of the extension member relative to the base frame at locations between the predetermined positions via a second engagement arrangement.

### CROSS REFERENCE TO RELATED APPLICATIONS

This nonprovisional patent application claims priority to provisional patent application Ser. No. 63/449,150 filed Mar. 1, 2023, the entire contents of which are hereby incorporated by reference.

### BACKGROUND AND SUMMARY

This patent application relates generally to a level of the type used in construction, and more particularly to a plate level such as is typically used for positioning an assembled component, such as a wall, in a desired orientation during construction.

Various types of levels for use in construction projects are known. Most levels are formed of a frame with a fixed length. The level frame is intended to be placed on a surface, and sensing components mounted to the frame determine the orientation of the surface relative to a predetermined angle, such as level, plumb or some other angle, such as a 45° angle. The sensing components may be, for example, bubble vials or digital angle detectors.

In some applications, it is desirable to have a level in which the length of the frame can be adjusted. In a representative application, the length of the frame of an adjustable length level can be selected to allow the level to be temporarily engaged with an underlying construction component. A plate level is commonly used in such an application. The plate level generally has a base frame component, with an extendable frame component being telescopingly engaged with the base frame component. Both the base frame component and the extendable frame component are provided with engagement structure that can be engaged with spaced-apart surfaces, such as upper and lower plates of a wall section. The extendable frame component is extended relative to the base frame component so that the engagement structure of the extendable frame component is engaged with one of the spaced-apart wall plates and the engagement structure of the base frame component is engaged with the other of the spaced apart wall plates.

The present invention provides an extendable-length or plate level having features that provide ease-of-use and that facilitate quick and easy engagement between spaced-apart members, such as top and bottom wall plates.

In accordance with an aspect of the present invention, an extendable level includes a base frame having an internal passage, an extension member positioned within the internal passage and movable between an extended position and a retracted position relative to the frame, and a retainer mechanism for securing the extension member in position relative to the frame. The retainer mechanism is in the form of a modular retainer assembly that can be assembled as a unit to the base frame.

The base frame may include a longitudinal passage within which the extension member is positioned, and the modular retainer assembly is engageable with the base frame within an interior portion of the base frame located adjacent the longitudinal passage. The base frame defines first and second ends, and the extension member is extendable and retractable relative to the first end of the base frame. The interior portion of the base frame within which the modular retainer assembly is engageable opens onto the first end of the base frame.

The modular retainer assembly may be secured to a collar configured for engagement with the first end of the base frame, and the collar may include a retainer assembly mounting portion to which the modular retainer assembly is secured. The collar may include a guide portion in alignment with the internal passage of the base frame within which the extension member is positioned, and the guide portion of the collar includes an opening through which the extension member extends.

The modular retainer assembly may include a first engagement arrangement that selectively prevents movement of the extension member relative to the base frame at predetermined positions of the extension member relative to the base frame, and a second engagement arrangement that resists movement of the extension member relative to the base frame at locations between the predetermined positions.

The first engagement arrangement may be in the form of a retainer pin that is movably mounted to the modular retainer assembly for movement between an extended position and a retracted position, and the modular retainer assembly may include a biasing arrangement that biases the retainer pin toward the extended position. The extension member may include one or more openings that come into alignment with the retainer pin during movement of the extension member between the extended and retracted positions, and the biasing arrangement is operable to move the retainer pin into one of the openings to selectively fix the position of the extension member relative to the base frame. The modular retainer assembly may further include a movable release member that is interconnected with the retainer pin and that is engageable by a user for selectively moving the retainer pin out of engagement within an opening in the extension member, so as to enable the extension member to be moved relative to the base frame between the extended and retracted positions.

The second engagement arrangement of the modular retainer assembly may be in the form of a brake shoe carried by the modular retainer assembly. The brake shoe may include a braking surface that is biased toward a surface of the extension member and that resists movement of the extension member between the extended and retracted positions. The modular retainer assembly may include a housing within which the brake shoe is contained, and the housing defines an opening through which the brake shoe extends for engagement with the surface of the extension member.

In accordance with another aspect of the present invention, an extendable level includes a base frame having an internal passage, and an extension member positioned within the internal passage and movable between an extended position and a retracted position relative to the base frame. A positioning arrangement is carried by the base frame and is configured to prevent movement of the extension member relative to the frame at predetermined positions of the extension member relative to the frame via a first engagement arrangement, and is further configured to resist movement of the extension member relative to the base frame at locations between the predetermined positions via a second engagement arrangement.

The base frame may include a longitudinal passage within which the extension member is positioned, and the positioning arrangement may be in the form of a retainer mechanism for securing the extension member in position relative to the base frame. The retainer mechanism may be located within an interior portion of the base frame located adjacent the longitudinal passage.

The retainer mechanism may be in the form of a modular retainer assembly that can be assembled as a unit to the base frame.

The first engagement arrangement may be in the form of a retainer pin that is movably mounted for movement between an extended position and a retracted position. A biasing arrangement biases the retainer pin toward the extended position, and the extension member includes one or more openings that come into alignment with the retainer pin during movement of the extension member between the extended and retracted positions. The biasing arrangement is operable to move the retainer pin into one of the openings to selectively fix the position of the extension member relative to the base frame. A movable release member is interconnected with the retainer pin and is engageable by a user for selectively moving the retainer pin out of engagement within an opening in the extension member, so as to enable the extension member to be moved relative to the base frame between the extended and retracted positions.

The second engagement arrangement may be in the form of a brake shoe, which includes a braking surface that is biased toward a surface of the extension member and that resists movement of the extension member between the extended and retracted positions.

Other aspects, features and advantages of the invention will become apparent to those skilled in the art from the following detailed description and accompanying drawings. It should be understood, however, that the detailed description and specific examples, while indicating certain embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements can be several views, and in which:

FIG. 1 is an isometric view of an extendable length level in accordance with the present invention;

FIG. 2 is an isometric view of the extendable length level of FIG. 1 in a representative application, shown in engagement with top and bottom plates of a wall assembly in a lowered position;

FIG. 3 is a plan view of the extendable length level of FIG. 1 and its engagement with the top and bottom plates of a wall assembly as in FIG. 2;

FIG. 4 is a plan view similar to FIG. 3 showing the extendable length level and wall assembly in a raised position;

FIG. 5 is an enlarged partial isometric view of an end portion of the extendable length level of FIG. 1, showing a base frame and an extension member of the extendable length level in a retracted position;

FIG. 6 is an enlarged partial isometric view of the end portion of the extendable length level as in FIG. 5, showing movement of the extension member toward an extended position relative to the base frame;

FIG. 7 is an enlarged partial isometric view of the end portion of the extendable length level as in FIG. 5, with portions removed top illustrate a retainer assembly for maintaining the position of the extension member relative to the base frame;

FIG. 8 is an exploded isometric view illustrating a retainer assembly incorporated in the extendable length level as in FIGS. 5 and 6;

FIG. 9 is an exploded isometric view a mounting arrangement for securing the retainer assembly of FIG. 8 in position on the extendable length level;

FIG. 10 is an exploded isometric view of the retainer assembly of FIGS. 8 and 9;

FIG. 11 is a section view taken along line 11-11 of FIG. 5, showing a release mechanism incorporated into the retainer assembly in a release position; and

FIG. 12 is a section view similar to FIG. 11, showing the release mechanism in an engaged position.

In describing the preferred embodiment of the invention that is illustrated in the drawings, specific terminology will be resorted to for the sake of clarity. However, it is not intended that the invention be limited to the specific terms so selected, and it is to be understood that each specific term includes all technical equivalents, which operate in a similar manner to accomplish a similar purpose. For example, the words “connected,” “attached,” or terms similar thereto are often used. They are not limited to direct connection but include connection through other elements where such connection would be recognized as being equivalent by those skilled in the art.

### DETAILED DESCRIPTION

The present invention and the various features and advantageous details thereof are explained more fully with reference to the non-limiting embodiments described in detail in the following description.

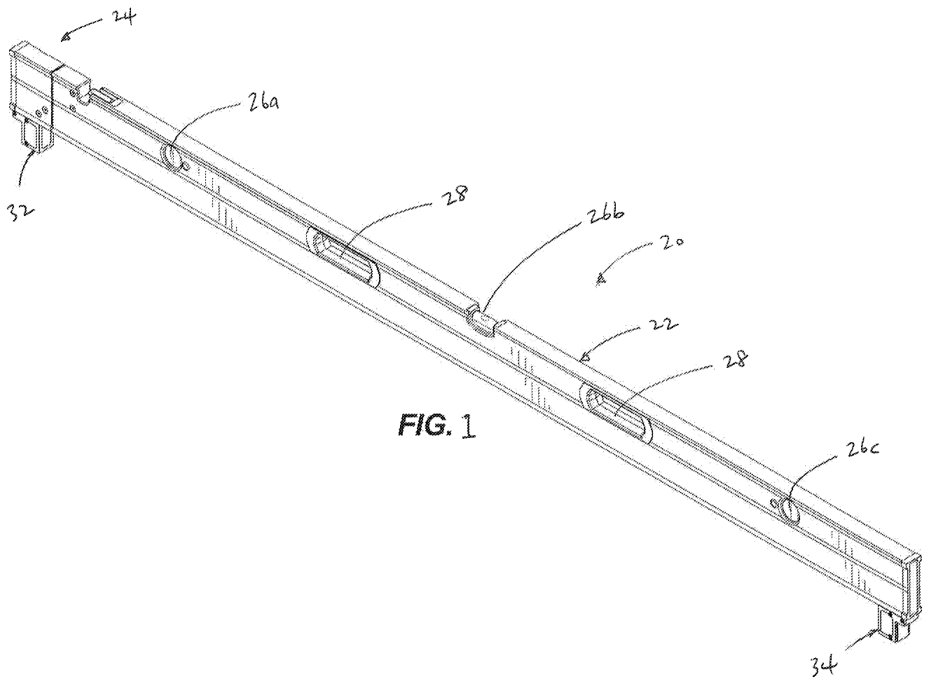

As shown in FIG. 1, a plate level 20 in accordance with the present invention generally includes a base or main level frame 22 and an extension section 24. In a manner as is known, the main frame 22 of plate level 20 includes a series of level vials such as shown at 26a, 26b, 26c, which are oriented to provide an indication of the orientation of plate level 20 relative to various planes, such as horizontal, vertical, 45°, etc. Indicators other than level vials may be employed, such as digital angle sensors or the like as is known in the art.

The top wall of main frame 22 may be provided with openings or windows to provide visibility for level vials 26a, 26b. In addition, the main frame 22 is provided with handgrips 28 that facilitate handling of plate level 20 by a user. In a typical construction, main frame 22 is in the form of an extrusion formed a metal such as aluminum, although any satisfactory construction or material may be employed. Vials 26a, 26b and 26c, as well as handgrips 28, are secured to mainframe 22 in a conventional manner, such as is employed in the construction of a box beam level.

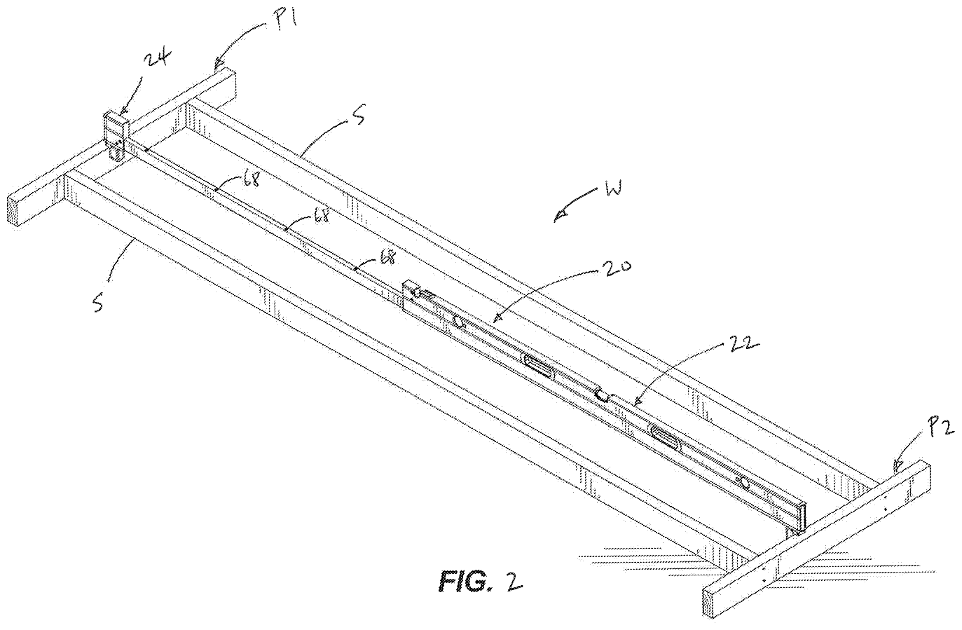

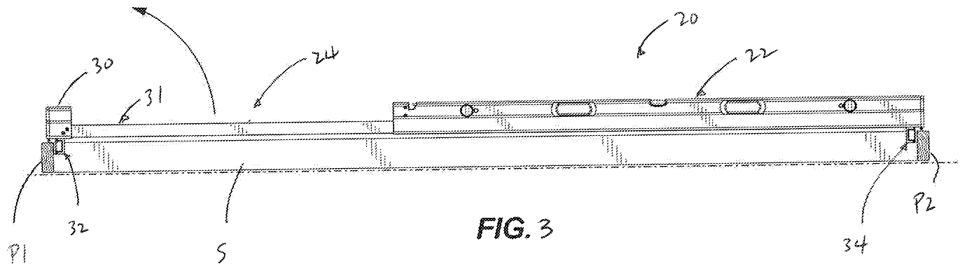

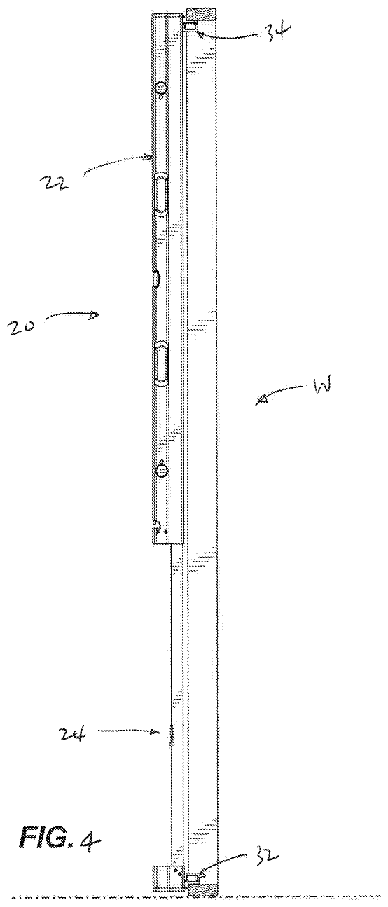

FIGS. 2-4 illustrate a common application for plate level 20. Representatively, the plate level 20 may be used to position a construction component, such as a wall section W, during rough construction. Typically, the wall section W will have a pair of plates P1, P2, between which a series of wall studs S extended. As shown in FIGS. 2 and 3, one end of main frame 22 is engaged with one of the plates, such as P2, and extension section 24 is extended relative to main frame 22 and is engaged with the other one of the plates P1. As shown in FIG. 4, the wall section W is then raised in a location at which it is to be installed, and plate level 20 is employed to ensure the wall section W is vertically oriented.

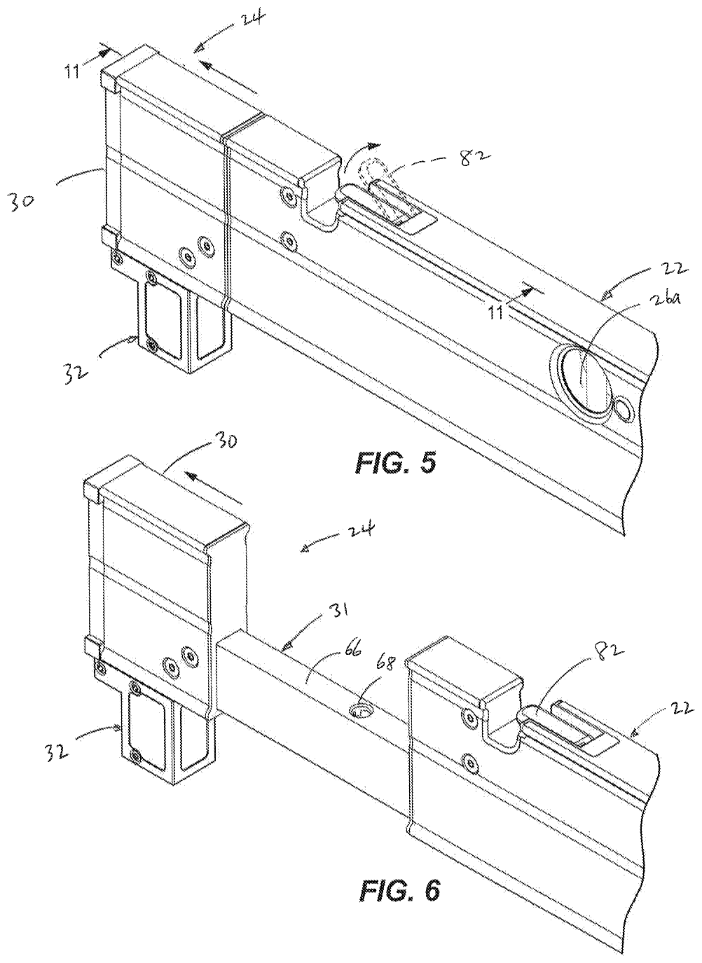

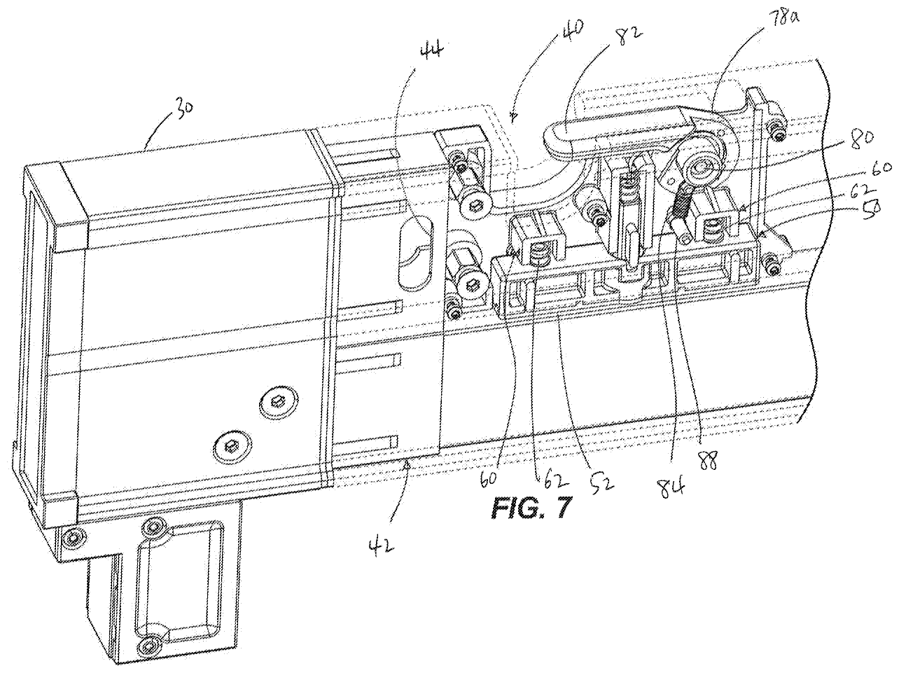

Referring to FIGS. 5 and 6, at one end of plate level 20 an end member 30 is secured to the outer end of an extension member 31. The end member 30 and extension member 31 together make up the extension section 24. An engagement member 32 extends laterally from the end member 30.

Referring again to FIGS. 1 and 3, at the opposite end of plate level 20 an engagement member 34 extends laterally from the end of main frame 22.

Main frame 22 is formed with an axially extending internal passage within which extension member 31 of extension section 24 is received. As noted, extension member 31 may be extended from or retracted toward the end of main frame 22 in order to adjust the distance between upper engagement member 32 and lower engagement member 34.

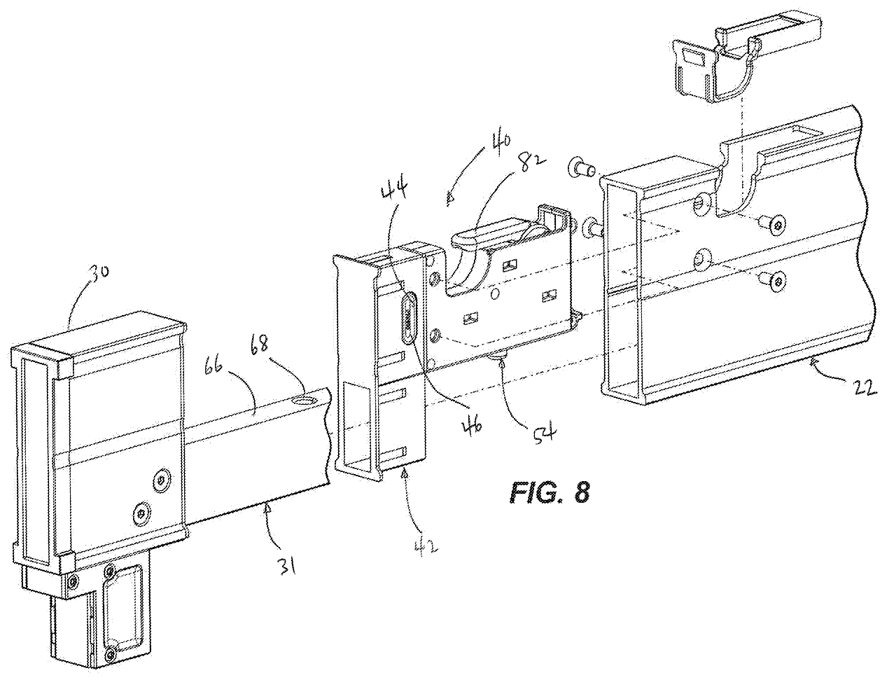

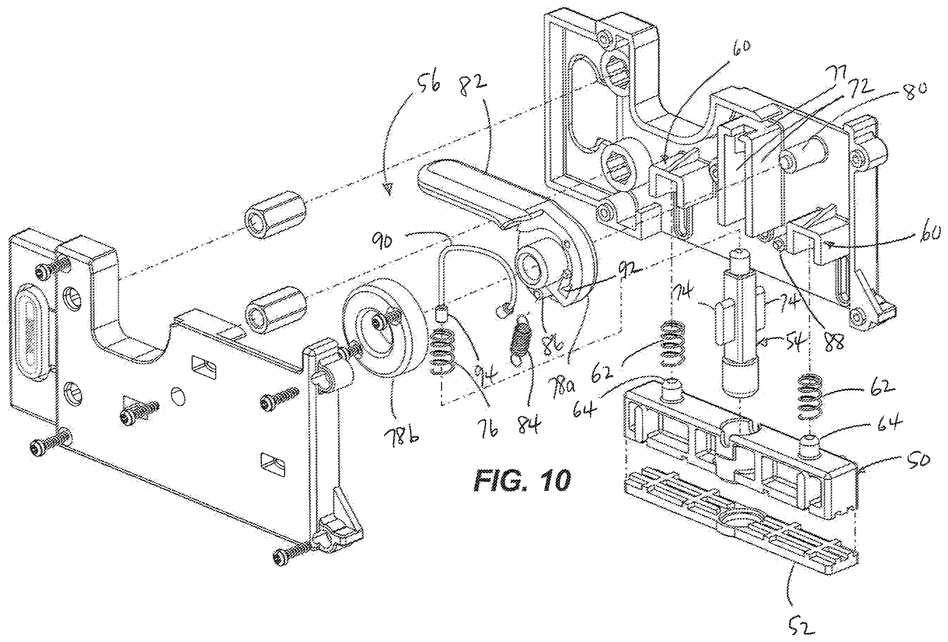

As shown in FIGS. 7-10, a combination retainer and retainer and locking assembly 40 is positioned at the end of main frame 22 in order to selectively lock the position of the extension member 31 relative to main frame 22.

The retainer and retainer and locking assembly 40 is in the form of a modular assembly that can be installed into a passage defined by the main frame 22 as a unit during initial assembly. If necessary, the initially installed modular retainer and retainer and locking assembly 40 may be removed from the main frame 22 as a unit, and a replacement modular retainer and retainer and locking assembly 40 may be installed in the same manner as installation during initial manufacture.

A collar 42 is engaged with the end of main frame 22. The collar 42 defines an opening corresponding in shape to the external configuration of extension member 31, to enable extension member 31 to be moved inwardly and outwardly relative to collar 42. The collar 42 also defines a pair of side openings 44, within which a pair of biased engagement tabs 46 of retainer and locking assembly 40 may be engaged. In this manner, the retainer and locking assembly 40 may be secured to collar 42 by engagement of the biased engagement tabs 46, and the assembled retainer and locking assembly 40 and the collar 42 may be inserted into the open end of main frame 22 in order to secure retainer and locking assembly 40 within the internal passage of main frame 22 extending inwardly from its end.

Generally, retainer and locking assembly 40 includes a housing 48 within which a brake shoe 50 having a brake pad 52 is contained. A locking pin 54 is located within the interior of housing 48, and an actuator assembly 56 is rotatably mounted to housing 48 adjacent locking pin 54. The housing 48 may be formed of a pair of generally mirror-image housing sections that are secured together to define an internal cavity within which brake shoe 50, brake pad 52 and actuator assembly 54 are contained. Each section of housing 48 is formed so as to include one of the engagement tabs 46.

The inner face of housing 48 is formed with an elongated generally rectangular opening 58. The brake pad 52 is positioned within the opening 58, and an outer wall of brake shoe 50 bears against the inner surface of brake pad 52. The outer surface of brake pad 56 faces and engages the outer side wall of extension member 31.

The interior of housing 48 is provided with a pair of spring engagement structures 60. The spring engagement structures 60 have an inverted cup shape, and each is configured to receive a spring 62 within its interior. Each spring 62 bears between the top wall of one of the spring engagement structures 60 and the upper surface of the brake shoe 50, which includes a pair of upstanding pegs 64 with which the lower ends of springs 62 are engaged. The springs 62 function to apply a biasing force on the brake shoe 50 that tends to urge it outwardly from the interior of the housing 48 through the opening 58 in the inner face of the housing 48, into engagement with the outer sidewall of extension member 31, shown at 66. The biasing forces applied by the springs 62, in combination with the friction surface of brake pad 52, are designed such that the extension member 31 is held in position when it is extended or retracted relative to the main frame 22. That is, the extension member 31 can be manually moved inwardly and outwardly relative to the main frame 22 to a desired position and, when the desired position attained, the manual force on the extension member 31 is removed and the springs 62, brake shoe 50 and brake pad 52 prevent relative movement between the extension member 31 and the main frame 22 by engagement of the brake pad 52 with the extension member 31.

The outer sidewall 66 of the extension member 31 is formed with a series of spaced-apart openings, such as shown at 68. The openings 68 may be located at evenly spaced intervals along the length of the extension member 31, such as evenly spaced six-inch or one-foot increments (although it is understood that any other desired spacing arrangement may be employed). Typically, the spacing of the openings 68 will correspond to increments in conventional ceiling heights, since plate level 20 will frequently be employed to position a floor-to-ceiling wall frame in a plumb orientation as previously described.

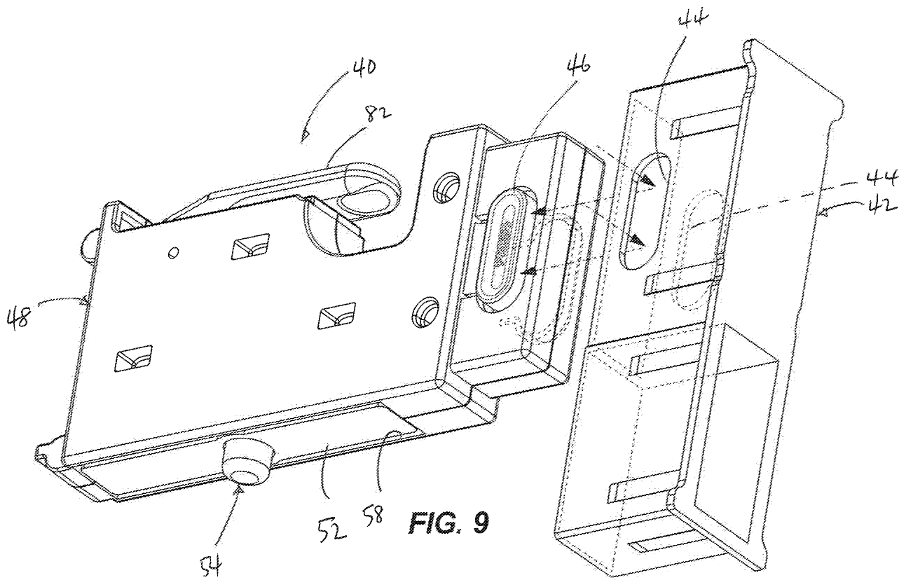

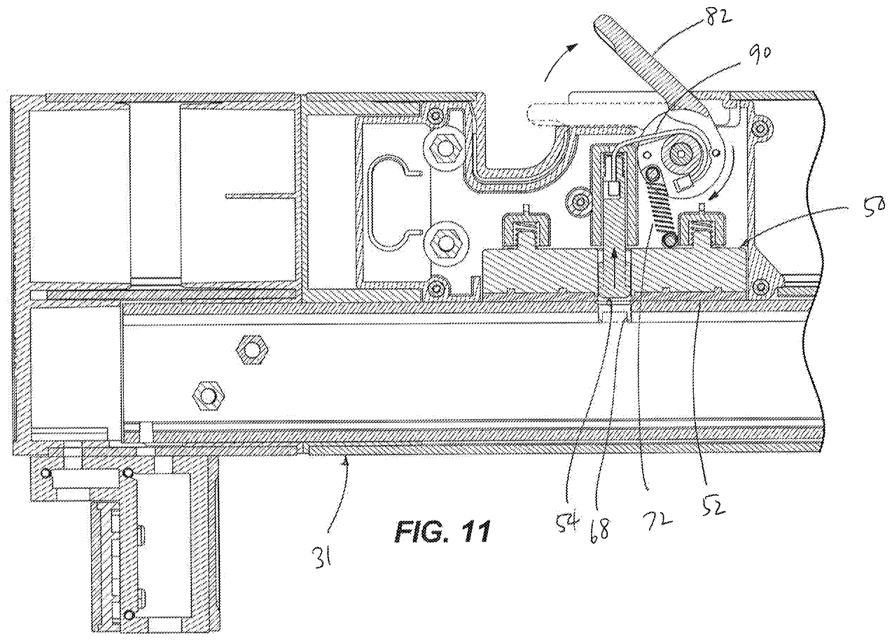

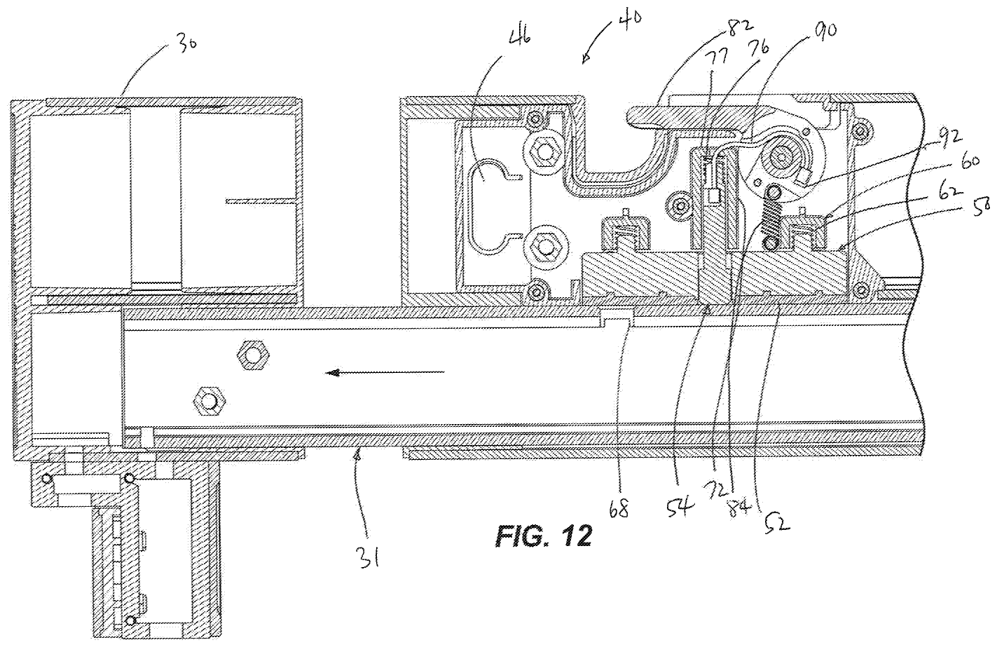

Retainer and locking assembly 40 includes the locking pin 54, which is configured to be received within an opening 68. The locking pin 54 is guided for inward-outward movement within the interior of housing 48, between a pair of guide walls 72. The locking pin 54 may include a pair of guide tabs, such as 74, that are received within suitably formed guide slots within the interior of housing 48. With this arrangement, locking pin 54 is guided for inward-outward movement between an extended position as shown in FIG. 9, and a retracted position as shown in FIGS. 11 and 12 (to be explained). A spring 76 bears between the upper end of locking pin 54 and an upper wall 77, which extends between the upper ends of sidewalls 72. The locking pin 54 has a reduced-diameter portion at its upper end, with which the lower end of the spring 76 is engaged. Spring 76 functions to urge locking pin 54 toward its extended position.

Actuator assembly 56 includes a hub formed by a pair of hub sections 78a, 78b, which is rotatably mounted within the interior of housing 48 via a shaft 80 that extends through a transverse passage in the central area of hub. The shaft 80 may extend between and be supported by the sidewalls of housing 48, although it is understood that any other satisfactory rotatable mounting construction may be employed for enabling rotatable movement of the hub formed by hub sections 78a, 78b. Actuator assembly 56 further includes a trigger or lever 82, which extends from and is rigidly interconnected with hub section 78a. A spring 84 is connected between a pin 86 of hub section 78a and a stationary pin 88 provided in the interior of housing 48. A cable 90 is secured at one end to an anchor 92 provided on hub section 78a, and extends through an opening in upper wall 77 and is secured at its opposite end to the upper end of locking pin 54, such as via a bead 94. Actuator assembly 56 is selectively operable to selectively move locking pin 54 from its extended position to its retracted position against the outward biasing force of spring 76, in a manner to be explained.

In operation, extension member 31 may be initially in a retracted position within the passage of frame 22 within which it is received. In an application in which plate level 20 is employed to position a building component such as a wall frame in a vertical orientation, the engagement member 34 is engaged with one of the wall plates, such as wall plate P2. The user then extends the extension member 31 relative to frame 22. During such movement, the inner end of locking pin 72 rides against the sidewall of extension member 31 as shown in FIG. 12. When one of the openings 68 in the sidewall 66 of extension member 31 comes into alignment with the locking pin 54, the inner end of locking pin 54 is forced into the extension member opening 68 under the influence of locking member spring 76, so as to fix the position of extension member 31 relative to frame 22. If the extension length of extension member 31 is suitable for the wall height, the engagement member 32 will have come into contact with the wall plate P1 so that the plate level 22 can then be used to properly position the wall section S. If, however, further extension of extension member 31 is necessary, the user manually engages the lever 82 and lifts it from its normal, at-rest position as shown in FIG. 12 to its raised, operative position as shown in FIG. 11. As lever 82 is lifted, the hub formed by hub sections 78a, 78b is rotated in a clockwise direction, which spools cable 90 onto the central area of the hub and applies tension to cable 90. The tension in cable 90 functions to lift locking pin 54 against the force of spring 76, to disengage the end of locking pin 54 from the opening 68 in extension member sidewall 66. This enables further extension of extension member 31 as shown in FIG. 12. The user then releases engagement with lever 82, and the biasing force of spring 84 acts on hub section 78 to move it in a counterclockwise direction so as to return lever 82 to its lowered position, which relieves the tension on cable 90. This process is repeated, for wall heights that correspond to the preset extensions of extension member 31, until the desired length of plate level 20 is attained. After use, lever 82 is again moved to its raised position so that extension member 31 can be retracted. Alternatively, during further extension of extension member 31, the user may maintain lever 82 in the raised position so as to prevent locking pin 54 from moving into an opening 68 in the event the degree of additional extension exceeds the predetermined spacing between the openings 68.

In the event the desired length of plate level 20 does not correspond to one of the predetermined lengths for standard wall heights, the frictional engagement of the brake shoe 52 with the sidewall 66 of the extension member 31 will maintain the extension member 31 in its desired position, as described above, without engagement of the locking pin 54 with an opening 68.

As can be appreciated, retainer and locking assembly 40 may be in the form of a preassembled modular unit, which facilitates a relatively simple assembly process for plate level 20. The modular nature of retainer and locking assembly 40 also enables it to be supplied as a replacement part so that, in the event it is damaged or becomes inoperative, it can be quickly and easily removed and replaced by the end user.

Although the best mode contemplated by the inventor of carrying out the present invention is disclosed above, practice of the present invention is not limited thereto. It will be manifest that various additions, modifications and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments. It is also understood that the invention disclosed and defined herein extends to all alternative combinations of two or more of the individual features mentioned or evident from the text and/or drawings. All of these different combinations constitute various alternative aspects of the present invention.

I claim:

1. An extendable level, comprising a base frame having an internal passage, an extension member positioned within the internal passage and movable between an extended position and a retracted position relative to the frame, and a retainer mechanism for securing the extension member in position relative to the frame, wherein the retainer mechanism comprises a modular retainer assembly that can be assembled as a unit to the base frame.

2. The extendable level of claim 1, wherein the base frame includes a longitudinal passage within which the extension member is positioned, and wherein the modular retainer assembly is engageable with the base frame within an interior portion of the base frame located adjacent the longitudinal passage.

3. The extendable level of claim 2, wherein the base frame defines first and second ends, wherein the extension member is extendable and retractable relative to the first end of the base frame, and wherein the interior portion of the base frame within which the modular retainer assembly is engageable opens onto the first end of the base frame.

4. The extendable level of claim 3, wherein the modular retainer assembly is secured to a collar configured for engagement with the first end of the base frame, wherein the collar includes a retainer assembly mounting portion to which the modular retainer assembly is secured.

5. The extendable level of claim 4, wherein the collar further includes a guide portion in alignment with the internal passage of the base frame within which the extension member is positioned, wherein the guide portion of the collar includes an opening through which the extension member extends.

6. The extendable level of claim 2, wherein the modular retainer assembly includes a first engagement arrangement that selectively prevents movement of the extension member relative to the base frame at predetermined positions of the extension member relative to the base frame, and a second engagement arrangement that resists movement of the extension member relative to the base frame at locations between the predetermined positions.

7. The extendable level of claim 6, wherein the first engagement arrangement comprises a retainer pin that is movably mounted to the modular retainer assembly for movement between an extended position and a retracted position, wherein the modular retainer assembly includes a biasing arrangement that biases the retainer pin toward the extended position, and wherein the extension member includes one or more openings that come into alignment with the retainer pin during movement of the extension member between the extended and retracted positions, wherein the biasing arrangement is operable to move the retainer pin into one of the openings to selectively fix the position of the extension member relative to the base frame.

8. The extendable level of claim 7, wherein the modular retainer assembly further includes a movable release member that is interconnected with the retainer pin and is engageable by a user for selectively moving the retainer pin out of engagement within an opening in the extension member, so as to enable the extension member to be moved relative to the base frame between the extended and retracted positions.

9. The extendable level of claim 8, wherein the movable release member is accessible by a user via an opening in the base frame.

10. The extendable level of claim 6, wherein the second engagement arrangement of the modular retainer assembly comprises a brake shoe carried by the modular retainer assembly, wherein the brake shoe includes a braking surface that is biased toward a surface of the extension member and that resists movement of the extension member between the extended and retracted positions.

11. The extendable level of claim 10, wherein the modular retainer assembly comprises a housing within which the brake shoe is contained, and wherein the housing defines an opening through which the brake shoe extends for engagement with the surface of the extension member.

12. An extendable level, comprising a base frame having an internal passage, and an extension member positioned within the internal passage and movable between an extended position and a retracted position relative to the base frame, and a positioning arrangement carried by the base frame that is configured to prevent movement of the extension member relative to the frame at predetermined positions of the extension member relative to the frame via a first engagement arrangement, and that is further configured to resist movement of the extension member relative to the base frame at locations between the predetermined positions via a second engagement arrangement.

13. The extendable level of claim 12, wherein the base frame includes a longitudinal passage within which the extension member is positioned, and wherein the positioning arrangement comprises a retainer mechanism for securing the extension member in position relative to the base frame, wherein the retainer mechanism is located within an interior portion of the base frame located adjacent the longitudinal passage.

14. The extendable level of claim 13, wherein the retainer mechanism comprises a modular retainer assembly that can be assembled as a unit to the base frame.

15. The extendable level of claim 14, wherein the base frame defines first and second ends, wherein the extension member is extendable and retractable relative to the first end of the base frame, and wherein the interior portion of the base frame within which the modular retainer assembly is engageable opens onto the first end of the base frame.

16. The extendable level of claim 15, wherein the modular retainer assembly is secured to a collar configured for engagement with the first end of the base frame, wherein the collar includes a retainer assembly mounting portion to which the modular retainer assembly is secured.

17. The extendable level of claim 16, wherein the collar further includes a guide portion in alignment with the internal passage of the base frame within which the extension member is positioned, wherein the guide portion of the collar includes an opening through which the extension member extends.

18. The extendable level of claim 12, wherein the first engagement arrangement comprises a retainer pin that is movably mounted for movement between an extended position and a retracted position, and a biasing arrangement that biases the retainer pin toward the extended position, wherein the extension member includes one or more openings that come into alignment with the retainer pin during movement of the extension member between the extended and retracted positions, wherein the biasing arrangement is operable to move the retainer pin into one of the openings to selectively fix the position of the extension member relative to the base frame.

19. The extendable level of claim 18, further comprising a movable release member that is interconnected with the retainer pin and is engageable by a user for selectively moving the retainer pin out of engagement within an opening in the extension member, so as to enable the extension member to be moved relative to the base frame between the extended and retracted positions.

20. The extendable level of claim 19, wherein the movable release member is accessible by a user via an opening in the base frame.

21. The extendable level of claim 12, wherein the second engagement arrangement comprises a brake shoe, wherein the brake shoe includes a braking surface that is biased toward a surface of the extension member and that resists movement of the extension member between the extended and retracted positions.
